(19) United States
(12) Patent Application Publication
(10) Pub. No.: US 2025/0042276 A1
(43) Pub. Date: Feb. 6, 2025

(54) CHARGING CONNECTION DEVICE FOR A VEHICLE WHICH CAN BE ELECTRICALLY DRIVEN

(71) Applicant: MERCEDES-BENZ GROUP AG, Stuttgart (DE)

(72) Inventors: Mark RENNER, Esslingen (DE); Karina KOHLER, Boeblingen (DE); Juergen BENECKE, Ludwigsburg (DE); Holger STEIN, Arnsberg (DE)

(21) Appl. No.: 18/717,485

(22) PCT Filed: Dec. 3, 2022
(86) PCT No.: PCT/EP2022/084319

§ 371 Date: Jun. 7, 2024

(30) Foreign Application Priority Data
Dec. 9, 2021 (DE) 10 2021 006 077.6

(51) Int. Cl. B60L 53/16; B60L 53/10; H01R 13/447

(52) U.S. Cl. CPC B60L 53/16; H01R 13/447; B60L 53/11

(57) ABSTRACT

A charging connection device, for an electrically drivable vehicle, includes two charging connections arranged next to each other and electrically coupled via a shared electrical path, each of the charging connections is assigned to at least one charging mode. A movably mounted cover element covers both charging connections in a covering position, uncovers a first charging connection and covers a second charging connection in a first uncovering position, and covers the first charging connection and uncovers the second charging connection and in a second uncovering position, so that during a charging process, only one charging connection assigned to a current charging mode is accessible at a time in order to be contacted, while the other one of the two charging connections is covered by the cover element.

### BACKGROUND AND SUMMARY OF THE INVENTION

Exemplary embodiments of the invention relate to a charging connection device for an electrically drivable vehicle, comprising two charging connections.

DE102021000307A1 discloses a charging connection device for an electrically drivable vehicle, comprising two charging connections arranged next to each other, having a first DC charging connection and a second DC and/or AC charging connection. The charging connection device additionally comprises at least one charging connection cover, which covers at least one of the two charging connections. The charging connection cover is designed such that only one of the two charging connections at a time is accessible to be contacted, while the other of the two charging connections is covered by the charging connection cover.

According to the prior art, electric cars require a dedicated charging connection for each charging standard, and therefore two charging connections are also provided on the vehicle for two charging options according to different standards.

One charging standard can include direct current charging, by which is meant charging with direct current, or alternating current charging, by which is meant charging with alternating current.

A charging standard currently used in Europe is, for example, the so-called Combined Charging System (CCS). Charging with direct current and alternating current is thus possible. A further standard, CHAdeMO=“Charge de Move”, as a standard developed in Japan, offers a charging capacity of up to 50 kW.

For alternative or future charging standards with capacities of several hundred kilowatts or even more with capacities of at least one megawatt and more, a further charging connection, in particular a DC voltage connection, is provided according to a further, alternative plug standard. Several charging connections can be electrically interconnected in a path, so that the charging sockets are simultaneously supplied with voltage.

Exemplary embodiments of the invention are directed to an improved charging connection device for an electrically drivable vehicle comprising two charging connections.

Favorable embodiments and advantages of the invention result from the description and the drawings.

According to one aspect of the invention, a charging connection device for an electrically drivable vehicle is disclosed, comprising two charging connections arranged next to each other and electrically coupled via a shared electrical path, and each of which is assigned to at least one charging mode. The charging connection device comprises a movably mounted cover element. The cover element covers both charging connections in a covering position. The cover element uncovers a first charging connection and covers a second charging connection in a first uncovering position. The cover element covers the first charging connection and uncovers the second charging connection in a second uncovering position. As a result, during a charging process, only one charging connection assigned to a current charging mode is accessible at a time in order to be contacted, while the other of the two charging connections is covered by the cover element, in particular covered such that it cannot be touched.

In the following, a charging connection is understood to mean a device, for example a charging socket, which is electrically coupled to an energy storage device and which can be electrically connected to a corresponding plug, which is electrically coupled to a voltage source. In the connected state, the energy storage device of the electrically drivable vehicle is charged by the voltage source. The charging connection has contact elements arranged in the form of a connector face, whereby the plug has a connector face with contact elements arranged congruently with contact elements of the charging connection. The two charging connections differ in the arrangement and/or in the design of the contact elements.

Due to an electrical path shared by the two charging connections, it is sufficient to use only one contactor in the electrical architecture of the high-voltage on-board power supply of the vehicle to connect the electrical energy storage device. Costs, installation space, and weight can thus be saved in comparison with a connection with two contactors. If the two charging connections are arranged in a shared electrical path, both charging connections are simultaneously supplied with voltage.

The respective charging connections or the contact elements not required for the current charging mode are mechanically covered by the cover element.

Due to the movably mounted cover element, the charging connection device can essentially have three states, wherein in a first state, both charging connections are covered by the same cover element. In a second state of the charging connection device, the contact elements of the second charging connection can be covered by the cover element. As a result, in the second state only the contact elements of the first charging connection are uncovered for at least one first charging mode. In a third state of the charging connection device, the first charging connection can be covered by the cover element. As a result, in the state only the contact elements of the second charging connection are uncovered for at least one second charging mode.

Due to these states of the charging connection device, it is only possible to couple a charging plug of a charging cable with the corresponding contact elements of the charging connection if the other charging connection or the contact elements that are not required are covered by the cover element such that they cannot be touched. This can advantageously ensure that the unused contact elements that are being supplied with voltage are covered such that they cannot be touched while the energy storage device is charging. In addition, the unused contact elements that are being supplied with voltage can be advantageously protected from environmental influences such as dirt or water. In addition, the cover element reliably covers the charging connections during the journey or during parking when the vehicle is not being charged and protects the charging connections from environmental influences and possible contact. In this case, the states can be implemented cost-effectively by a single cover element and a simple mechanism which moves the cover element into the various positions.

A voltage-free connection of one of the charging connections can advantageously be dispensed with due to the cover element. A corresponding changeover device, a so-called switch box, can thus be dispensed with, whereby additional costs and additional installation space can be saved.

According to an advantageous embodiment of the charging connection device, the two charging connections can be arranged in a shared charging cradle. In the case of an arrangement in a shared charging cradle, the charging connections can be arranged on the vehicle in a space-saving manner. In addition, the cover element can be designed as a charging cradle cover element. Here, the charging cradle cover element in the covering position can cover and seal the charging cradle with the two charging connections.

According to one advantageous embodiment of the charging connection device, the cover element can have two covering sections, wherein in the covering position, each section can cover a respective charging connection. In the first uncovering position, a first covering section can cover the second charging connection. In the second uncovering position, a second covering section can cover the first charging connection. In this case, the cross-section of the cover element can correspond to the cross-section of the charging cradle. The cover element can be moved from the covering position to the side in order to move the first section from the first charging connection in direction of the second charging connection. The cover element can be moved from the covering position to the other side in order to move the second section from the second charging connection in the direction of the first charging connection.

According to one advantageous embodiment of the charging connection device, in each of the uncovering positions, a covering section can project at least partially beyond a cross-section of the charging cradle. In this case, the cover element can be displaced outwards in front of a bodyshell in order to be moved into one of the uncovering positions. Alternatively, or additionally, in each of the uncovering positions, a covering section can be arranged in a receptacle. In this case, the cover element can be displaced inwards under the bodyshell in order to be moved into one of the uncovering positions.

According to an alternative embodiment of the charging connection device, the cover element can have at least one covering section and an uncovering section. In the covering position, the at least one covering section can cover the charging connections. In the first uncovering position, the at least one uncovering section can at least partially uncover the first charging connection and the at least one covering section can cover the second charging connection cover. In the second uncovering position, the at least one uncovering section can at least partially uncover the second charging connection and the at least one covering section can cover the first charging connection. The cover element can, for example, be designed as a perforated mask, in particular as a pliable, circumferentially arranged or rollable and unrollable perforated sheet.

According to one advantageous embodiment of the charging connection device, at least one sealing strip can be arranged between the two charging connections. This sealing strip can be made of plastic. In this case, the sealing strip can extend between the two charging connections. Alternatively, the sealing strip can be arranged surrounding one of the charging connections. In particular, a sealing strip can extend around each of the two charging connections. The covered charging connection is additionally protected by the sealing strip from touch and environmental influences.

According to one advantageous embodiment of the charging connection device, at least one of the two charging connections can be designed as a combined DC/AC charging connection, in particular as a CCS charging connection having two types of contact elements. AC contact elements form a first connector face that can be coupled to a connector face of a plug with congruent contact elements in order to charge the vehicle or the energy storage device thereof with alternating current. The DC contact elements form a second connector face. A plug, which is coupled to the combined DC/AC charging connection in order to charge the vehicle or the energy storage device thereof with direct current, has two connector faces which can be coupled to the two connector faces of the combined DC/AC charging connection. An additional charging connection cover can be assigned to DC contact elements of the combined DC/AC charging connection. The additional charging connection cover can have a position that uncovers the DC contact elements and a position that covers the DC contact elements. The additional charging connection cover can, in this case, be arranged between the combined DC/AC charging connection and the cover element, whereby the cover element also covers the additional charging connection cover in the position that uncovers the other charging connection and in the covering position. Due to the additional charging connection cover, the charging connection device can have a further state. In the first state, in which the cover element uncovers the combined DC/AC charging connection, only the AC contact elements are uncovered by the additional charging connection cover in the covering position. The DC contact elements are covered by the additional charging connection cover. In a fourth state, the cover element has the position that uncovers the combined DC/AC charging connection and the additional charging connection cover has the position that uncovers the DC contact elements. As a result, the AC contact elements and the DC contact elements are uncovered. The other charging connection that is covered in the first state and in the second state can be designed as a DC charging connection or as an AC charging connection or as a further DC/AC charging connection. If the other charging connection also has various contact elements for different charging modes, further states of the charging connection cover are conceivable.

According to an advantageous embodiment of the charging connection device, the cover element and/or the charging connection cover can be embodied as a flap that is mounted such that it can be moved translationally and/or rotationally. In this case, the charging connection cover can be moved in order to be transitioned into the uncovering position so that it does not cover the AC contact elements in the uncovering position. A multiplicity of suitable movement options for the transition between the positions are made possible for both flaps. The flaps, in particular the charging connection cover, can be folded or pivoted downwards or to the side or diagonally outwards on a suitable axis, away from the charging connection or from the charging cradle, in order to be moved into the uncovering position. For example, the flap can be arranged in a similar manner as a typical fuel flap on the side of the combined DC/AC charging connection. As an alternative, the flaps can be rotated in a plane parallel to the charging cradle. As an alternative, the flaps can be displaced upwards or downwards or to the side via a corresponding guide, in order to be moved into one of the uncovering positions. The respective flap can, in this case, be displaced outwards in front of a bodyshell or can be displaced inwards under the bodyshell, in order to be moved into one of the uncovering positions. A combination of pivoting and rotating or of pivoting and displacing or of rotating and displacing is also conceivable. In addition, the cover element and the charging connection cover can be moved in different ways. Alternatively, the charging connection cover and/or the cover element can be designed as a roller blind that can be rolled up or moved away inwards or folded away inwards in an S-shape. The roller blind can be designed as an arrangement of slats or as a pliable spring sheet.

According to one advantageous embodiment of the charging connection device, at least one drive can drive the cover element and/or the charging connection cover. The movement of the cover element and/or the charging connection cover can take place fully automatically or semi-automatically via an electric servomotor or a plurality of servomotors.

According to one advantageous embodiment of the charging connection device, at least one sensor assembly coupled to the at least one drive can determine a current charging mode. By determining the current charging mode, the required contact elements that are assigned to the current charging mode can be determined. Depending on the charging mode detected by the sensor assembly, the at least one drive can move the cover element and, if necessary, the charging connection cover into the position in which only the charging connection assigned to the charging mode or the contact elements of the charging connection assigned to the charging mode are uncovered. This makes fully automatic or semi-automatic uncovering of the required contact elements possible. The at least one sensor assembly can comprise a limit switch and/or an optical sensor and/or a camera. In addition, the sensor assembly can be connected to a charging column via a communication system in order to receive information about the selected charging mode.

Using the charging connection device according to the invention, it can advantageously be ensured that only one charging connection at a time or certain contact elements are accessible in order to be contacted, and the other charging connection is or the other contact elements are each covered such that they cannot be touched.

Further advantages result from the following description of drawings. An exemplary embodiment of the invention is depicted in the drawings. The drawings, the description and the claims contain numerous features in combination. The person skilled in the art will also expediently consider the features individually and combine them to form logical further combinations.

### BRIEF DESCRIPTION OF THE DRAWING FIGURES

The drawings show:

FIG. 1 a charging connection device for an electrically drivable vehicle having two charging connections having completely covered charging connections;

FIG. 2 the charging connection device according to FIG. 1 having uncovered AC contact elements of a combined DC/AC charging connection;

FIG. 3 the charging connection device according to FIGS. 1 and 2 having uncovered AC contact elements and DC contact elements of the combined DC/AC charging connection; and

FIG. 4 the charging connection device according to FIGS. 1 to 3 with uncovered further charging connection.

Identical or similar components are denoted with the same reference signs in the figures. The figures only show examples, and should not be understood as restrictive.

### DETAILED DESCRIPTION

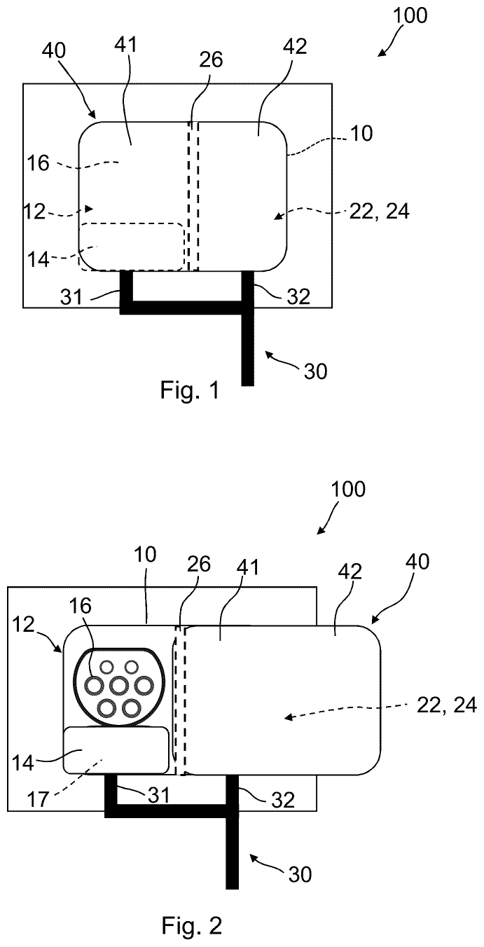

FIGS. 1 to 4 show a charging connection device 100 for an electrically drivable vehicle having two charging connections 12, 22.

As can be seen from FIGS. 1 to 4, the depicted exemplary embodiment of the charging connection devices 100 for an electrically drivable vehicle comprises, in each case, two charging connections 12, 22 arranged next to each other.

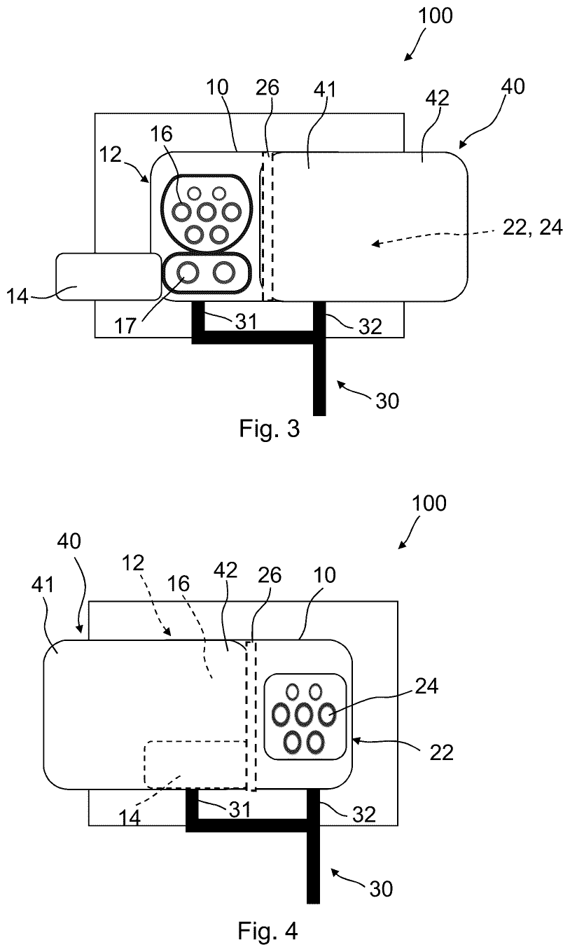

As can further be seen from FIGS. 1 to 4, the charging connections 12, 22 correspond to charging sockets, but other suitable charging connections 12, 22 are also conceivable. As can further be seen from FIGS. 2 and 3, a charging connection 12 arranged on the left in the corresponding exemplary embodiment of the charging connection device 100 is designed as a combined DC/AC charging connection 12. The charging connection 22 arranged on the right can be designed as a DC charging connection 22 or as an AC charging connection 22 or as a further combined DC/AC charging connection 22. The charging connections 12, 22 are each assigned to at least one charging mode.

Naturally, the designation left and right are examples. The depicted combined DC/AC charging connection 12 can naturally also be arranged on the right. The two charging connections 12, 22 can furthermore also be arranged one below the other. In addition, the two charging connections can each have only one type of contact element 16, 17, 24.

As can further be seen from FIGS. 1 to 4, the charging connections 12, 22 are electrically coupled via a shared electrical path 30. The two charging connections 12, 22 arranged next to each other in the shared electrical path 30 are connected in parallel. Each charging connection 12, 22 in this case respectively has an electrical coupling 31, 32. No isolators are required in this case to isolate the charging connections 12, 22. The two charging connections 12, 22 are supplied with voltage.

As can further be seen from FIG. 3, the combined DC/AC charging connection 12 has two types of contact elements 16, 17. The AC contact elements 16 are arranged above DC contact elements 17.

As can further be seen from FIGS. 1 to 4, the charging connection device 100 comprises a movably mounted cover element 40. In a covering position (FIG. 1), the cover element 40 covers two charging connections 12, 22. In a first uncovering position (FIG. 2), the cover element 40 uncovers the first charging connection 12 designed as a combined DC/AC charging connection 12 and covers a second charging connection 22. In a second uncovering position (FIG. 4), the cover element 40 covers the first charging connection 12 and uncovers the second charging connection 22. As a result, during a charging process, only one charging connection 12, 22 assigned to a current charging mode is accessible at a time in order to be contacted, whiles the other of the two charging connections 12, 22 is covered by the cover element 40, in particular covered such that it cannot be touched. As a result, it is only possible to plug a plug into the corresponding charging connection 12, 22 or to couple it with the corresponding contact elements 16, 17, 24 if the other charging connection 12, 22 or the other contact elements 16, 17, 24, which are not assigned to the charging mode assigned to the plug, are covered such that they cannot be touched. This ensures that the unused charging connection 12, 22 supplied with voltage, or unused contact elements 16, 17,24, are covered during charging such that they cannot be touched. In addition, the unused charging connection 12, 22 supplied with voltage, or the unused contact elements 16, 17,24, are protected from environmental influences such as dirt or water.

As can further be seen from FIGS. 1 to 4, the two charging connections 12, 22 are arranged in a shared charging cradle 10. The cover element 40 is designed as a charging cradle cover element and covers the charging cradle 10 in the covering position.

As can further be seen from FIGS. 1 to 4, the cover element 40 has two covering sections 41, 42, wherein in the covering position, each section 41, 42 covers a respective charging connection 12, 22. In the exemplary embodiment shown, the first section 41 covers the first charging connection 12 and the second section 42 covers the second charging connection 22 in the covering position. In the first uncovering position (FIGS. 2 and 3), the first covering section 41 covers the second charging connection 22. In the second uncovering position (FIG. 4), the second covering section 42 covers the first charging connection 12. For this purpose, in the exemplary embodiment shown, the covering sections 41, 42 are displaced from the position in the covering position of the cover element 40 in the direction of the other charging connection 12, 22, in order to cover the latter. The section 41, 42, that covers this charging connection 12, 22 in the covering position of the cover element 40, is moved away from the charging connection 12, 22 during this displacement. In this case, the cover element 40 is embodied as a flap mounted such that it can move translationally, wherein the cover element 40 is displaced in front of the bodyshell, whereby in each of the uncovering positions, a section 41, 42 projects at least partially beyond a cross-section of the charging cradle 10. In an alternative exemplary embodiment (not shown), it is also possible to displace the cover element behind the bodyshell. In this case, in each of the uncovering positions, a section 41, 42 can be arranged at least in a receptacle.

In an alternative embodiment (not shown), another arrangement of the covering sections 41, 42 and a movement other than the pushing movement shown is also possible in order to move the cover element 40 and thus its sections 41,42.

As can further be seen from FIGS. 1 to 4, at least one sealing strip 26, which is marked with a dashed line, is arranged between the two charging connections 12, 22. The sealing strip 26 extends between the two charging connections 12, 22. In an alternative exemplary embodiment (not shown), a sealing strip 26 is arranged in each case surrounding each charging connection 12, 22. The sealing strip 26 can be made of plastic or another suitable material.

As can further be seen from FIGS. 1 to 4, in the exemplary embodiment shown, an additional charging connection cover 14 is assigned to the DC contact elements 17 of the combined DC/AC charging connection 12. The charging connection cover 14 has a position (FIG. 3) uncovering the DC contact elements 17 and a position (FIG. 2) covering the DC contact elements (17).

In the exemplary embodiment shown, the charging connection cover 14 is embodied as a flap that is mounted such that it can move translationally. In this case, the flap can be moved into the uncovering position by being pushed to the left, to the right and downwards. In an alternative exemplary embodiment (not shown), the charging connection cover 14 can also be designed as a flap that is mounted such that it can move rotationally or as a roller blind.

A drive (not shown) can drive the cover element 40 and/or the charging connection cover 14. In addition, at least one sensor assembly (not shown) coupled to the at least one drive can determine a current charging mode. As a result, depending on the charging mode detected by the sensor assembly, the at least one drive can move the cover element 40 and/or the charging connection cover 14 into the position in which only the charging connection 12, 22 assigned to the charging mode or the contact elements 16, 17, 24 of the charging connection assigned to the charging mode are uncovered. As a result, it is possible to uncover the required contact elements fully automatically or semi-automatically.

In the state of the charging connection device 100 shown in FIG. 1, the charging connections 16, 16, 24 and the charging connection cover 14 are covered by the cover element 40.

In the state of the charging connection device 100 shown in FIG. 2, the DC contact elements 17 of the combined DC/AC charging connection 12 are covered by the charging connection cover 14 and the other charging connection 22 is covered by the cover element 40. As a result, in the state shown, only the AC contact elements 16 of the combined DC/AC charging connection 12 for a CCS AC charging mode are uncovered.

In the state of the charging connection device 100 shown in FIG. 3, the other charging connection 22 is covered by the cover element 40. The DC contact elements 17 are uncovered. As a result, in state shown, the AC contact elements 16 and the DC contact elements 17 of the combined DC/AC charging connection 12 for a CCS DC charging mode are uncovered.

In the state of the charging connection device 100 shown in FIG. 4, the combined DC/AC charging connection 12 and the charging connection cover 14 are covered in the covering position by the cover element 40 and the other charging connection 22 and the contact elements 24 thereof are uncovered for a corresponding charging mode. If the other charging connection 22 also has various types of contact elements 24 for different charging modes, further states are conceivable.

In an alternative exemplary embodiment (not shown), the cover element 40 can have at least one covering section 41, 42 and an uncovering section. In the covering position, the at least one covering section 41, 42 can cover the charging connections 12, 22. In the first uncovering position, the at least one uncovering section can uncover the first charging connection 12 and the at least one covering section 41, 42 can cover the second charging connection 22. In the second uncovering position, the at least one uncovering section can uncover the second charging connection 22 and the at least one covering section 42 can cover the first charging connection 12. In this case, the cover element 40 can be designed as a displaceable perforated mask, wherein the uncovering section has a cut-out or an opening or a recess in the form of the connector face assigned to the charging mode or at least in the form of the connection 12,22 assigned to the charging mode. By way of example, the cover element 40 can have a covering section 41, 42 and two uncovering sections. The covering section 41, 42 can be arranged in the centre of the cover element 40 and have the covering position in a central position. An uncovering section is arranged in each case to the left and to the right of the covering section 41, 42, so that to uncover a charging connection 12, 22, the cover element 40 is displaced to the right or left into the respective uncovering position in order to move the uncovering section over the charging connection 12, 22 to be uncovered. In this case, the perforated mask can be embodied as a foldable or roll-up or pliable roller blind. The roller blind can be made of plastic or sheet metal, which can be folded, rolled up, or moved away inwards. In addition, the roller blind can fold away inwards in an S-shape. The movement can be executed upwards, downwards, to the left or to the right.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### List of References

10 charging cradle
12 charging connection
14 charging connection cover
16 AC contact elements
17 DC contact elements
22 charging connection
24 contact elements
26 sealing strip
30 electrical path
31, 32 electrical coupling
40 cover element
41 first covering section
42 second covering section
100 charging connection device

1-10. (canceled)

11. A charging connection device for an electrically drivable vehicle, the charging connection device comprising:
two charging connections, which are charging sockets, arranged next to each other, and electrically coupled via a shared electrical path, wherein each of two charging connections is assigned to at least one charging mode;
a movably mounted cover element; and
at least one drive drives configured to drive the movably mounted cover element or an additional charging connection cover,
wherein the movably mounted cover element covers both of the two charging connections in a covering position, uncovers a first of the two charging connections and covers a second of the two charging connections in a first uncovering position, and covers the first of the two charging connections and uncovers the second of the two charging connections in a second uncovering position, so that during a charging process, only one of the two charging connections that is assigned to a current charging mode is accessible at a time in order to be contacted while another of the two charging connections is covered by the cover element such that it cannot be touched.

12. The charging connection device of claim 11, wherein the two charging connections are arranged in a shared charging cradle.

13. The charging connection device of claim 11, wherein the movably mounted cover element has two covering sections, wherein in the covering position, each of the two sections covers a respective one of the two charging connections, wherein in the first uncovering position, a first of the two covering sections covers the second charging connection, wherein in the second uncovering position, a second of the two covering sections covers the first charging connection.

14. The charging connection device of claim 13, wherein in each of the first and second uncovering positions, a covering section of the two covering sections projects at least partially beyond a cross-section of the charging cradle or is arranged in a receptacle.

15. The charging connection device of claim 11, wherein the cover element has at least one covering section and at least one uncovering section, wherein in the covering position, the at least one covering section covers the two charging connections, wherein in the first uncovering position, the at least one uncovering section at least partially uncovers the first charging connection and the at least one covering section covers the second charging connection covers, wherein in the second uncovering position, the at least one uncovering section at least partially uncovers the second charging connection and the at least one covering section covers the first charging connection.

16. The charging connection device of claim 11, further comprising:
at least one sealing strip arranged between the two charging connections.

17. The charging connection device of claim 11, wherein at least one of the two charging connections is a combined DC/AC charging connection having AC contact elements and DC contact elements, wherein the additional charging connection cover is assigned to DC contact elements, wherein the additional charging connection cover has a position that uncovers the DC contact elements and a position that covers the DC contact elements.

18. The charging connection device of claim 11, wherein the movably mounted cover element or the additional charging connection cover is a flap that is mounted such that it is translationally or rotationally movable.

19. The charging connection device of claim 18, further comprising:
at least one sensor assembly coupled to the at least one drive and configured to determine the current charging mode.
